(19) United States
(12) Patent Application Publication
(10) Pub. No.: US 2006/0109358 A1
(43) Pub. Date: May 25, 2006

(54) System on a chip camera system employing complementary color filter

(76) Inventors: Dong-Seob Song, Chungcheongbuk-do (KR); Byung-Geun Jung, Chungcheongbuk-do (KR); Oh-Bong Kwon, Chungcheongbuk-do (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/100,237

(22) Filed: Apr. 5, 2005

(30) Foreign Application Priority Data
Nov. 24, 2004 (KR) 2004-97138

(51) Int. Cl. H04N 3/14; H04N 5/335; H04N 9/04; H04N 9/083

(52) U.S. Cl. 348/275; 348/302; 348/279

(57) ABSTRACT

A system on a chip (SoC) camera system includes a pixel array which has a color filter and converts an optically photographed image to an electrical analog image signal, an analog signal processing unit for adjusting the electrical analog image signal outputted from the pixel array to a predetermined level to thereby output a digital image signal, and a digital signal processing unit for performing white color compensation and color revision to make the digital image signal close to an original image, wherein the digital signal processing unit is integrated with the pixel array and the analog signal processing unit in one chip. The SoC camera system employs a complementary color filter adopting a progressive scanning scheme of reading all pixels at one time and outputting color signals to thereby obtain an image having improved resolution and color sensitivity.

### FIELD OF THE INVENTION

The present invention relates to a system on a chip (SoC) camera system employing a complementary color filter; and, more particularly, to a SoC camera system employing a CMOS image sensor including a complementary color filter and a signal processing circuit for processing image signals from the image sensor which are implemented in the form of SoC, wherein the complementary color filter adopts a progressive scanning scheme of reading all pixels at one time and outputting color signals to thereby obtain the image signals having high resolution and color sensitivity.

### BACKGROUND OF THE INVENTION

In general, an image sensor is a semiconductor device which converts photons to electrons, and displays the electrons on a display device or stores them in a storing device. The image sensor is basically classified to a charge coupled device (CCD) image sensor and a complementary metal oxide semiconductor (CMOS) image sensor. Furthermore, according to its functions, there are an area image sensor used in a digital camera, a video camera and so on, and a linear image sensor adopted in a facsimile, a scanner, a multifunctional office instrument, etc. Nowadays, the image sensor is widely used in various cameras, camcorders, facsimiles, medical instruments, etc.

Among the image sensors, the CMOS image sensor is cheaper than the CCD image sensor and has power consumption as much as 1/10 of that of the CCD image sensor. Moreover, the CMOS image sensor has a high degree of integration, so that it can be implemented in the form of SoC with peripheral integrated circuits. As a result, the CMOS image sensor is easily applicable to the digital camera requiring a smaller and lighter image sensor than the CCD image sensor.

Meanwhile, the image sensor should include a color filter for color classification to thereby identify colors from inputted color images. As the color filter, there are a conventional primary color filter as described in FIG. 3A and a conventional complementary color filter as shown in FIG. 3B.

Referring to FIG. 3A, there is provided a view showing an array of the conventional primary color filter consisting of three color components such as red R, green G and blue B. In FIG. 3A, the color components are arrayed periodically with a basic unit having a pixel array of R-G-G-B (referring to a dotted line portion in FIG. 3A), G-R-B-G, B-G-G-R or G-B-R-G. The basic unit has total 4 pixels (2 row pixels×2 column pixels).

Generally, visible light can be divided into R, G and B according to its wavelength. The color filter used in the image sensor is an organic compound which selectively passes light in a band of certain wavelength. The primary color filter consisting of the color components, R, G and B, can reproduce precise colors by passing the 3 primary colors of R, G and B, while it has deteriorated resolution since its pixels do not have sufficient intensity of radiation compared to the complementary color filter.

Referring to FIG. 3B, there is described a view showing an array of the conventional complementary color filter consisting of four color components such as a cyan Cy, a magenta Mg, a yellow Ye and a green Gr. As shown in FIG. 3B, the color components are arrayed periodically with a basic unit having a pixel array of Cy-Ye-Gr-Mg (referring to a dotted line portion in FIG. 3B), Ye-Cy-Mg-Gr, Mg-Gr-Ye-Cy or Gr-Mg-Cy-Ye. The basic unit has total 4 pixels (2 row pixels×2 column pixels). The color components, Cy, Mg and Ye, constructing the complementary color filter are complementary colors of the color components, R, G and B, constituting the primary color filter.

The complementary color filter does not pass one of the color components, R, G and B. That is, a Ye filter passes R and G (Ye=R+G); a Cy filter passes G and B (Cy=G+B); and Mg filter passes R and B (Mg=R+B). Since each of the Ye, Cy and Mg filters does not pass its own color component by absorbing it, the intensity of radiation of primary color signals inputted to the image sensor becomes higher. Herein, a Gr filter passes G. Namely, since the complementary color filter can pass double components than the primary color filter with it one filter, its luminous intensity becomes higher and, as a result, it is possible to obtain advanced image signals when photographing a dark subject. Furthermore, since the complementary color filter can extract all of R, G and B from four pixels (Cy, Mg, Ye and Gr) like the primary color filter, the resolution is hardly deteriorated.

In particular, in case of total 4 pixels (=row 2 pixels×column 2 pixels), it is easily noticed from the following results that the complementary color filter passes the color components about twice than the primary color filter.

Primary color filter:
R+G+G+B=2G+R+B

Complementary color filter:
Cy+Mg+Ye+Gr=3G+2R+2B

As can be seen from the above, since the intensity of radiation is decreased in case of the primary color filter, noises are also increased when electrically amplifying image signals. In this case, since the complementary color filter has about twice higher permeability than that of the primary color filter, it can produce images having low noise and higher sensitivity is obtained. Therefore, recently, the complementary color filter is generally employed in a camera system using the CMOS image sensor such as a video camera or a digital camera in which the sensitivity is important.

In the meantime, the image sensor adopting the complementary color filter uses the interlaced scanning scheme so as to reproduce image signals. Therefore, the camera system using the CMOS image sensor employing the complementary color filter should have a function of converting the complementary signals Cy, Mg, Ye and Gr to the primary color signals R, G and B since systems such as a personal computer (PC) uses the primary color signals R, G and B.

Referring to FIG. 4, there is explained a method of reproducing image signals by using the interlaced scanning scheme at the image sensor using the complementary color filter described in FIG. 3B. The interlaced scanning scheme is a method of extracting R, G and B signals from one field and constructing one color signal from the R, G and B signals. This scheme will be explained in detail hereinafter.

At first, after obtaining Y (luminance), Cb (=B−Y, chromaticity for B) and Cr (=R−Y, chromaticity for R) by using Cy, Mg, Ye and Gr values in a 2×2 area of the array of the complementary color filter, there are made the R, G and B values by using the Cy, Mg, Ye and Gr values. That is,
(in 1st frame) Cy+Mg, Ye+Gr, Cy+Mg, Ye+Gr,
(in 2nd frame) Gr+Cy, Mg+Ye, Gr+Cy, Mg+Ye,
By repeating the above, Y, Cb and Cr values are obtained as follows.
(in 1st frame) Y=(Cy+Mg+Ye+Gr)/4
Cb (Cy+Mg)−(Ye+Gr)
(in 2nd frame) Y=(Gr+Cy+Mg+Ye)/4
Cr=(Mg+Ye)−(Gr+Cy)

Accordingly, the R, G and B values are determined as follows by the conversion to the primary signals from the Y, Cb and Cr values. However, because of not only mathematically converting the Y, Cb and Cr to the R, G and B but also applying a result based on an examination for optimizing each coefficient under the best color tone and the best resolution, the image sensor has following equations for the conversion to the primary signals. Also, a hardware implementation is one of consideration factors for optimizing each coefficient for the conversion.
R=1/8.(Y−Cb+3Cr)=1/2.(G+Cr)
G=1/4.(Y−Cb−Cr)
B=1/8.(Y+3Cb−Cr)=1/2.(G+Cb)

However, the interlaced scanning scheme is a scheme of reading in an even field and an odd field sequentially. That is to say, after dividing a screen into even fields and odd fields, one image is made by displaying an even field at one time and displaying an odd field at the next time. By using the interlaced scanning scheme, it is possible to accomplish a high refresh rate since a relatively stabilized image can be obtained from half data. On the other hand, since the picture is divided into two and scanned through two time scanning, its resolution decreases to a half and it is not appropriate to transmit high density information.

Although there were provided methods which improve resolution and color sensitivity by adopting digital signal processing in the camera system using the image sensor employing the complementary color filter, the conventional methods could not accomplish integration of circuits and, thus, a signal processing circuit is separated from the image sensor. As a result, in case of adopting the CCD image sensor which cannot accomplish miniaturization/light weight, there needs a camera system capable of advancing the resolution and the color sensitivity as well as satisfying the miniaturization/light weight which are requirements of the digital camera employing the CCD image sensor.

### SUMMARY OF THE INVENTION

It is, therefore, an object of the present invention to provide a camera system capable of accomplishing miniaturization/light weight by implementing a CMOS image sensor including a complementary color filter so at to compensate the deterioration of color sensitivity and a signal processing circuit for processing image signals transmitted from the image sensor in the form of system on a chip (SoC).

It is, therefore, another object of the present invention to provide a camera system adopting a progressive scanning scheme of reading all pixels at one time and outputting color signals so as to obtain image signals and improve resolution.

It is, therefore, another object of the present invention to provide a camera system for precisely reproducing color information through image signal processing such as complementary-primary color conversion, white color compensation and color revision by using a signal processing circuit.

In accordance with the present invention, there is provided a camera system comprising a pixel array which includes a color filter and converts an optically photographed image to an electrical analog image signal, an analog signal processing unit for adjusting the electrical analog image signal outputted from the pixel array to a predetermined level to thereby output a digital image signal, and a digital signal processing unit for performing white color compensation and color revision to make the digital image signal close to an original image, wherein the digital signal processing unit is integrated with the pixel array and the analog signal processing unit in one chip.

### BRIEF DESCRIPTION OF THE DRAWINGS

The above and other objects and features of the present invention will become apparent from the following description of preferred embodiments given in conjunction with the accompanying drawings, in which:

FIG. 1 shows a detailed block diagram of a SoC camera system in accordance with the present invention;

FIG. 2 illustrates a view explaining a method for performing white color compensation at the SoC camera system in accordance with the present invention;

FIG. 3A provides a view showing an array of a conventional primary color filter;

FIG. 3B describes a view showing an array of a conventional complementary color filter; and

FIG. 4 represents a view explaining a method of reproducing image signals by using an interlaced scanning scheme at an image sensor using the conventional complementary color filter described in FIG. 3B.

### DETAILED DESCRIPTION OF THE PREFERRED EMBODIMENTS

Hereinafter, with reference to the drawings, some of the preferred embodiments of the present invention will be explained in detail.

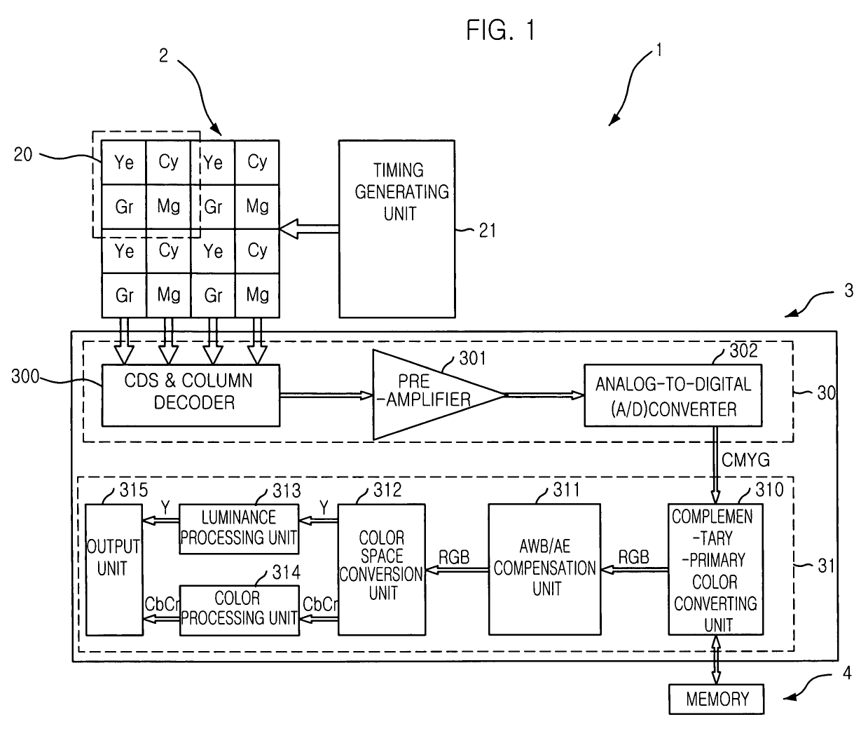

Referring to FIG. 1, there is shown a detailed block diagram of a SoC camera system in accordance with the present invention.

The SoC camera system 1 includes a pixel array 2 and a signal processing circuit 3. The pixel array 2 has a color filter 20 attached thereto and a timing generating unit 21, and the signal processing circuit 3 controls output signals of the pixel array 2, i.e., processes analog image signals provided from the pixel array 2 to convert preferred data signals for use in the SoC camera system. Further, the components, e.g., the pixel array 2, the signal processing circuit 3 and the timing generating unit 21, constructing the camera system 1 are made in the SoC, e.g., are formed in one chip, for accomplishing a miniaturization of the SoC camera system 1 and reducing a weight of the SoC camera system 1.

Herein, the pixel array 2 performs a photo-electricity conversion like a conventional image sensors and contains the color filter 20 and the timing generating unit 21. Since the pixel array 2 and other components execute the same functions as those of the general image sensors, detailed explanation about them will be omitted hereinafter.

In addition, it is preferable that the pixel array 2 employs a complementary color filter as the color filter 20 to compensate a color sensitivity deterioration. In this case, the complementary color filter employed in the present invention has a pixel array consisting of four type color components, i.e., a cyan Cy, a magenta Mg, a yellow Ye and a green Gr. The color components are arrayed periodically with a basic unit of Ye-Cy-Gr-Mg, Cy-Ye-Mg-Gr, Mg-Gr-Cy-Ye or Gr-Mg-Ye-Cy. The basic unit has total 4 pixels (2 row pixels by 2 column pixels). Herein, the basic unit of Ye-Cy-Gr-Mg (referring to a dotted line portion in FIG. 1) will be explained as a reference.

The pixel array 2 operates in response to a driving pulse generated from the time generating unit 21. Under the control of control signals provided from an auto white balance/auto exposure (AWB/AE) compensation unit 311, the timing generating unit 21 makes each pixel of the complementary filter 20 to be read according to the progressive scanning scheme and controls a light receiving time of each pixel. Furthermore, if image data obtained by photographing a subject through a camera lens is inputted, inputted images are classified by the complementary color filter 20 attached to the pixel array 2 and optically photographed images by inducing an energy through an internal optical diode are converted to electrical analog image signals. The electrically converted analog image signals are outputted to the signal processing circuit 3.

In the present invention, it is preferable that the pixel array 2 is a CMOS image sensor that is cheap and has low power consumption and a high degree of integration, so that it can be implemented in the form of SoC.

Although the complementary color filter is adopted to compensate the deterioration of color sensitivity, the camera system 1 in accordance with the present invention can employ a primary color filter instead of the complementary color filter. In this case, there does not need a signal converting procedure for converting complementary color signals to primary color signals.

The signal processing circuit 3, which controls the pixel array 2 employing the complementary color filter 20 and processes the analog image signals transmitted from the pixel array 2 to thereby generate preferred digital image signals, includes an analog signal processing unit 30 and a digital signal processing unit 31. Hereinafter, a reproduction to make the preferred digital image signals will be explained with reference to the components constructing the signal processing circuit 3.

The analog signal processing unit 30 adjusts each analog image signal provided from the pixel array 2 to each predetermined level to thereby output each digital image signals having a digital value corresponding to a level of each analog image signal. In detail, the analog signal processing unit 30 includes a CDS & column decoder 300, a pre-amplifier 301 and an analog-to-digital (A/D) converter 302.

The CDS & column decoder 300 performs a low noise process for reducing a noise of an output signal from the complementary color filter 20 of the pixel array 2. In the pixel array 2, there occurs a fixed pattern noise by an offset voltage because of a precise difference in a manufacturing process. Therefore, the CDS & column decoder 300 executes the low noise process by conducting correlated double sampling on a mixed signal of data components and noise components outputted from the pixel array 2, i.e., receiving electrical image signals and removing the noise components, then separating noise removed data components into column units and outputting the separated data Cy, Mg, Ye and Gr to the pre-amplifier 301 through a multiplexer (not shown).

The pre-amplifier 301 adjusts brightness of picture. That is, in response to the control signal from the AWB/AE compensation unit 311 of the digital signal processing unit 31, if the brightness of picture is higher or lower than a predetermined level, the pre-amplifier 301 adjusts a level of the noise removed signals, provided from the CDS & column decoder 300 through the multiplexer, to the predetermined level and outputs the level adjusted signals to the A/D converter 302.

The A/D converter 302 converts the analog image signals to the digital image signals. Namely, the A/D converter 302 receives the analog image signals which are generated by the complementary color filter 20 included in the pixel array 2 and each level of the analog image signals is adjusted to each predetermined level from the pre-amplifier 301, converts the received analog image signals to the digital image signal depending on offset controlled by an offset control signal, and outputs the digital image signals to the digital signal processing unit 31.

The digital signal processing unit 31 receives the digital image signals from the analog signal processing unit 30 to thereby perform the digital signal process such as the conversion to R, G and B signals, the white color compensation and signal processing for generating a color difference signal and, then, outputs the processed signals to external storing/reproducing devices (not shown) through an output terminal. The digital signal processing unit 31 contains a complementary-primary color converting unit 310, the AWB/AE compensation unit 311, a color space conversion unit 312, a luminance processing unit 313, a color processing unit 314 and an output unit 315.

The complementary-primary color converting unit 310 employs a 3×3 or 3×4 matrix circuit to convert the digital image signals Cy, Mg, Ye and Gr outputted from the A/D converter 302 of the analog signal processing unit 30 to the primary color signals R, G and B for changing the color response characteristics of the converted signals R, G and B to be adaptable to an international standard and performs color correction for compensating colors distorted by the pixel array 2.

In case of applying the progressive scanning scheme to obtain the analog images signals from the pixel array 2, there does not need to adopt color interpolation. The color interpolation means a method for changing low resolution image data of an image sensor to high resolution image data by estimating R, G and B color values of a corresponding pixel based on color values of neighboring pixels. In accordance with the present invention, since there is further employed a memory 4 connected to the complementary-primary color converting unit 310, it is possible to store image data of at least one line in the memory 4 and to extract R, G and B values for every field by reading in all pixels once. As a result, the color interpolation is not required.

In other words, four digital image signals Cy, Mg, Ye and Gr are required to perform the complementary-primary color conversion. If Gr and Mg signals of a second line are reading out, Ye and Cy signals of a first line are necessary. Therefore, it is preferable that the one line memory 4 is added to store the Ye and Cy signals of the first line.

Herein, according to the detailed explanation of the method for converting the Cy, Mg, Ye and Gr signals outputted from the complementary color filter 20 of the pixel array 2 in FIG. 1 to the R, G and B signals, following Y, Cr (=R−Y) and Cb (=B−Y) signals are generated in every line from the pixel array 2 in the progressive scanning scheme.
Y=(Cy+Gr+Ye+Mg)/4=(2B+3G+2R)/4
Cr=(Mg+Ye)−(Gr+Cy)=(2R−G)
Cb=(Mg+Cy)−(Gr+Ye)=(2B−G)

Since the complementary color filter 20 is used, if Mg=R+B, Ye=R+G and Cy=G+B, there are obtained following R, G and B values from the four pixels of Cy, Mg, Ye and Gr in every line through the conversion at the 3×4 matrix circuit of the complementary-primary color converting unit 310.
G=1/4.(Y−Cb−Cr)
R=1/8.(Y−Cb+3Cr)=1/2.(G+Cr)
B=1/8.(Y+3Cb−Cr)=1/2.(G+Cb)

Through not only mathematically converting the Y, Cb and Cr to the R, G and B but also applying a result based on an examination for optimizing each coefficient under the best color tone and the best resolution, above equations are determined. Also, a hardware implementation is one of consideration factors for determining each coefficient for the conversion.

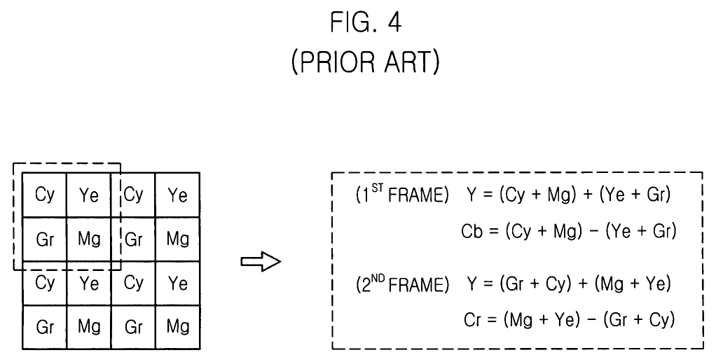

These results are similar to the method for reproducing the image signals by using the interlaced scanning scheme explained with reference to FIG. 4. However, unlike the interlaced scanning scheme, in accordance with the present invention, by adding the memory 4 and adopting the progressive scanning scheme, one field and the other one field stored in the memory 4, i.e., an even field and an odd field, are displayed on one screen, so that it is possible to obtain an image having high resolution.

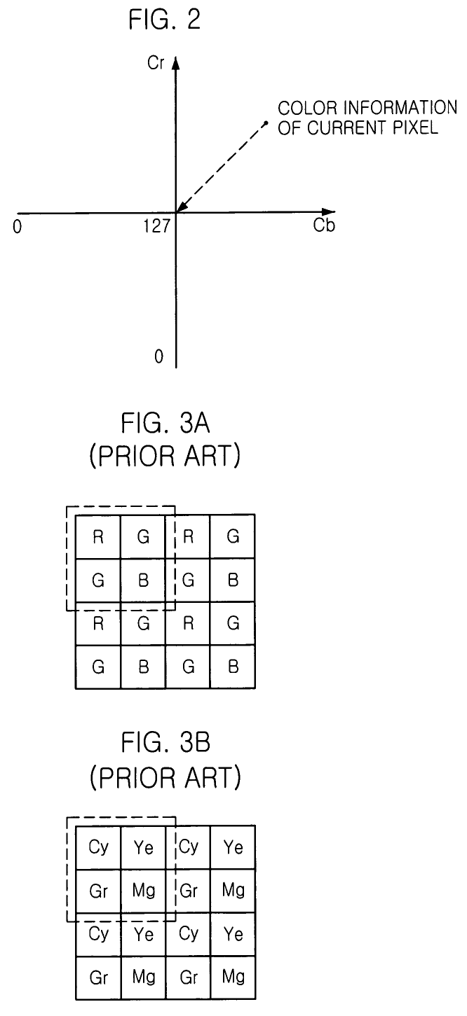

Te AWB/AE compensation unit 311 is employed to show a white subject, which is represented in different color according to light source such as a sunlight, a fluorescent lamp, an incandescent lamp and so on, in white color. For instance, in case of sunlight, color temperature is precisely changed according to conditions such as a time, a weather, a shadow, etc. Moreover, since atmosphere of a picture under sunlight and that of the picture under fluorescent lamp are substantially different, a photographer cannot obtain desired color. In order to photograph the best picture, white balance should be changed according to light. As described in FIG. 2, the auto white balance is performed by adjusting Cb and Cr value to about 127 code and converting a color value of a current pixel to a target value.

Furthermore, the AWB/AE compensation unit 311 generates the control signal by using the luminance value Y to obtain image signals having constant brightness of a certain level and then constantly adjusts the integration time which is a time each pixel receives light by the timing generating unit 21 and brightness of the pre-amplifier 301, i.e., the level of the signal obtained by removing noises from the output signal of the pixel array 2.

The color space conversion unit 312 converts the primary color signals R, G and B to a color space in which the primary color signals are divided to the luminance Y and the color components Cb and Cr, wherein Cb represents chromaticity for a blue color and Cr depicts chromaticity for a red color.

The luminance processing unit 313 and the color processing unit 314 are included to process an image closer to an original image by adjusting brightness and color, respectively. The luminance processing unit 313 processes a luminance signal at an amplification circuit and the color processing unit 314 generates a color difference signal by using the luminance signal, which is for the color difference signal, of the output signal provided from the color matrix circuit.

The output unit 315 outputs the digital signal processed image in desired various formats to make it similar to the original image like the conversion to R, G and B signals, white color compensation and signal processing for generating a color difference signal of other components of the digital signal processing unit 31. Through the above process, the image signal is transmitted to external storing/reproducing devices to be stored or reproduced.

In accordance with the present invention, by adopting the progressive scanning scheme to obtain the analog image signal and by using the signal processing circuit for performing the complementary-primary color conversion, the auto white color compensation, the color revision, the color information is correctly reproduced. As a result, the image outputted through the output unit 315 can have increased resolution and it is noted from the following comparison results that the output image signal of the SoC camera system according to the present invention is much clearer than that of the conventional camera system.

In a Table 1, simulation of the conventional camera system and the SoC camera system according to the present invention having the conditions described in the Table 1 was executed and their output image signals were compared in a resolution aspect. The conditions of the Table 1 can be changed according to a simulation body and the simulation is for explaining the SoC camera system according to the present invention in a concrete way.

Referring to the Table 1, as comparison examples of the present invention employing the complementary color filter and the progressive scanning scheme and implemented in the form of SoC, there are shown camera systems using 1) primary color filter and interlaced scanning scheme, 2) primary color filter and progressive scanning scheme, 3) complementary color filter and interlaced scanning scheme, and 4) complementary color filter and progressive scanning scheme. Herein, it took for granted that the above four examples were not implemented and their image sensor and signal processing circuit were separately formed to each other.

TABLE 1

| | Conditions | | |
|---|---|---|---|
| | | Scanning | Camera system |
| Items | Color filter | scheme | type |
| 1. Example 1 | Primary color | interlaced | Separated |
| 2. Example 2 | Primary color | Progressive | Separated |
| 3. Example 3 | Complementary | Interlaced | Separated |
| | color | | |
| 4. Example 4 | Complementary | Progressive | Separated |
| | color | | |
| 5. Present | Complementary | Progressive | System on a chip |
| invention | color | | |

According to the simulation results in the resolution aspect using the conditions of the Table 1, the present invention has resolution that is twice improved than the example 3 employing the complementary color filter and the interlaced scanning scheme. In particular, in case of the present invention contrary to above described examples 1 to 4, it is easily understood to substantially achieve and implement more efficient design and architecture of the SoC camera system. That is, the present invention can be reduce a size and a weight of the camera system.

As can be seen the above, in accordance with the SoC camera system according to the present invention, since the R, G and B signals are obtained through the Cy, Mg, Ye and Gr signal conversion, it is possible to obtain a picture having few incorrect colors, good color reproducibility and good image quality. Furthermore, it is possible to compensate the deterioration of the color sensitivity and improve the resolution.

In addition, the miniaturization/light weight can be achieved by constructing the CMOS image sensor and the signal processing circuit in the form of SoC. Therefore, the present invention is applicable to a digital camera requiring the miniaturization/light weight as an image input device of, e.g., PC.

As described above, in accordance with the present invention, high resolution image can be acquired by adopting the progressive scanning scheme. Moreover, there does not need the color interpolation since the R, G and B signals are extracted in a 2×2 region by adding the memory and the additional signal processing circuit.

The miniaturization/light weight can be accomplished by constructing the CMOS image sensor having the complementary color filter to compensate the deterioration of the color sensitivity and the signal processing circuit for processing the image signal provided form the image sensor in the form of SoC. The signal processing circuit can simply perform the signal processing by converting the complementary color signal to the color difference signal and then converting the color difference signal to the primary color signal without a complicated process to covert the complementary color signal to the primary color signal by adopting the digital signal processing in addition to the analog signal processing. In addition, there is an effect of precisely reproducing the color information through the image signal processing such as the complementary-primary color conversion, auto white color compensation and color revision.

The present application contains subject matter related to Korean patent application No. 2004-97138, filed in the Korean Patent Office on Nov. 24, 2004, the entire contents of which being incorporated herein by reference

While the present invention has been described with respect to the particular embodiments, it will be apparent to those skilled in the art that various changes and modifications may be made without departing from the spirit and scope of the invention as defined in the following claims.

What is claimed is:

1. A camera system, comprising:
a pixel array including a color filter for converting an optically photographed image to an electrical analog image signal;
an analog signal processing means for adjusting the electrical analog image signal outputted from the pixel array to a predetermined level to thereby output a digital image signal; and
a digital signal processing means for performing a white color compensation and a color revision to make the digital image signal close to an original image,
wherein the digital signal processing means is integrated with the pixel array and the analog signal processing means in one chip.

2. The camera system as recited in claim 1, which is constructed by a CMOS manufacturing process.

3. The camera system as recited in claim 1, wherein the color filter is a complementary color filter having 4 color components, Cy, Mg, Ye and Gr.

4. The camera system as recited in claim 1, further comprising:
a timing generating means for producing a driving pulse to control an exposure time which each pixel of the color filter receives light and make each pixel to be read according to a specific scanning scheme to thereby obtain the analog image signal.

5. The camera system as recited in claim 4, wherein a scanning scheme to obtain the analog image signal from the pixel array is a progressive scanning scheme.

6. The camera system as recited in claim 1, wherein the analog signal processing means includes:
a CDS/column decoder for reducing noises of the image signal outputted from the pixel array by performing correlated double sampling;
a pre-amplifier for constantly adjusting a level of the image signal processed by the CDS/column decoder to a certain level; and
an analog-to-digital converter for converting the analog image signal adjusted to the certain level to the digital image signal, and
the digital signal processing means includes:
a complementary-primary color converting means for the digital image signal, Cy, Mg, Ye and Gr, to primary color signals R, G and B and performing color revision;
a AWB/AE compensation means which performs white color compensation for a white subject, which is represented in different color according to light source, thereby making the white subject visible as white color;
a color space conversion means for converting primary color signals R, G and B to color difference signals Y, Cb and Cr;
a luminance processing means and a color processing means for adjusting brightness and color of the photographed image to make said image close to the original image; and
an output means for outputting the signal processed image to an external device in a certain format.

7. The camera system as recited in claim 6, wherein the complementary-primary color converting means is formed with one of a 3×4 matrix circuit and a 3×3 matrix circuit.

8. The camera system as recited in claim 6 further comprising a memory, connected to the complementary-primary color converting means, for storing image data.

9. The camera system as recited in claim 8, wherein the memory stores image data corresponding to at least one line.

10. The camera system as recited in claim 6, wherein the AWB/AE compensation means produces a control signal with a luminance value so as to adjust the brightness and an exposure time which each pixel of the color filter receives light, thereby controlling the timing generating means and the pre-amplifier.
